(19) United States
(12) Patent Application Publication
(10) Pub. No.: US 2016/0100329 A1
(43) Pub. Date: Apr. 7, 2016

(54) TECHNIQUES FOR DYNAMICALLY ADJUSTING THE STREAMING OF MEDIA CONTENT FROM A WIRELESS DEVICE

(71) Applicant: QUALCOMM Incorporated, San Diego, CA (US)

(72) Inventors: Arthur Joseph Miller, San Diego, CA (US); Srinivasan Balasubramanian, San Diego, CA (US)

(21) Appl. No.: 14/872,822

(22) Filed: Oct. 1, 2015

Related U.S. Application Data
(60) Provisional application No. 62/059,184, filed on Oct. 3, 2014.

(51) Int. Cl. H04W 28/02; H04W 72/04; H04B 17/309; H04L 29/06

(52) U.S. Cl. CPC H04W 28/0284; H04L 65/604; H04W 28/0268; H04W 72/0413; H04B 17/309

(57) ABSTRACT

Techniques are described for wireless communication. One method includes determining, by a wireless device, channel conditions associated with an uplink of a wireless network. The method also includes determining a loading parameter of a cell of the wireless network and dynamically adjusting a format of media content streamed from the wireless device over the wireless network based on the determined channel conditions and the loading parameter of the cell of the wireless network.

### CROSS REFERENCES

The present Application for Patent claims priority to U.S. Provisional Patent Application No. 62/059,184 by Miller et al., entitled “Techniques for Dynamically Adjusting the Streaming of Media Content From a Wireless Device,” filed Oct. 3, 2014, assigned to the assignee hereof, and expressly incorporated by reference herein.

### BACKGROUND

1. Field of the Disclosure

The present disclosure, for example, relates to wireless communication systems, and more particularly to techniques for dynamically adjusting the streaming of media content from a wireless device.

2. Description of Related Art

Wireless devices such as smartphones, or other wireless devices having a video or still camera, are often used to capture and upload media content. In some cases, the media content may be streamed in real-time. For example, a smartphone may be used for a video call, or a wearable camera may be used to capture first-person footage of a sporting event or another activity.

Under some conditions, the streaming of media content may not be possible (e.g., due to poor channel connection conditions). Under other conditions, the streaming of media content may be possible, but the quality may be poor.

### SUMMARY

The present disclosure, for example, relates to one or more techniques for dynamically adjusting the streaming of media content from a wireless device. Dynamic adjustment of the streaming of media content may support continuous streaming under conditions that did not previously support streaming. Also disclosed are techniques in which the streaming of media content may be delayed, and techniques in which a subset of media content to be streamed may be selected. Dynamic adjustments to the capture of media content are also disclosed. In some examples, the capture or streaming of media content at a first wireless device may be controlled by a second wireless device over an ad-hoc wireless connection.

A method for wireless communication is described. This method may include determining, by a wireless device, channel conditions associated with an uplink of a wireless network. This method may also include determining a loading parameter of a cell of the wireless network. Furthermore, this method may include dynamically adjusting a format of media content streamed from the wireless device over the wireless network based on the determined channel conditions and the determined loading parameter of the cell of the wireless network.

An apparatus for wireless communication is described. The apparatus may include means for determining channel conditions associated with an uplink of a wireless network. The apparatus may also include means for determining a loading parameter of a cell of the wireless network. Furthermore, the apparatus may include means for dynamically adjusting a format of media content streamed from a wireless device over the wireless network based on the determined channel conditions and the determined loading parameter of the cell of the wireless network.

Another apparatus for wireless communications is described. The apparatus may include a processor, memory in electronic communication with the processor, and instructions in the memory. The instructions may be operable to cause the apparatus to determine, by a wireless device, channel conditions associated with an uplink of a wireless network. The instructions may also be operable to cause the apparatus to determine a loading parameter of a cell of the wireless network. Furthermore, the instructions may be operable to cause the apparatus to dynamically adjust a format of media content streamed from the wireless device over the wireless network based on the determined channel conditions and the determined loading parameter of the cell of the wireless network.

A non-transitory computer-readable medium storing computer-executable code for wireless communication is described. The code may be executed by a processor to determine, by a wireless device, channel conditions associated with an uplink of a wireless network. The code may also be executed by a processor to determine a loading parameter of a cell of the wireless network. Furthermore, the code may be executed by a processor to dynamically adjust a format of media content streamed from the wireless device over the wireless network based on the determined channel conditions and the determined loading parameter of the cell of the wireless network.

Some examples of the method, apparatus, or non-transitory computer-readable medium described above may further include processes, features, means, or instructions for selecting a time to stream the media content over the wireless network based on at least one of: the determined channel conditions and the determined loading parameter of the cell of the wireless network.

In some examples of the method, apparatus, or non-transitory computer-readable medium described above, selecting the time to stream the media content may include delaying streaming the media content over the wireless network until the channel conditions improve or until the loading of the cell of the wireless network improves.

Some examples of the method, apparatus, or non-transitory computer-readable medium described above may further include processes, features, means, or instructions for determining a quality of service (QoS) provided by the cell of the wireless network, wherein the loading parameter of the cell of the wireless network may be determined based on the determined QoS.

Some examples of the method, apparatus, or non-transitory computer-readable medium described above may further include processes, features, means, or instructions for monitoring resource grants on a physical downlink control channel received from the cell of the wireless network, wherein the loading parameter of the cell of the wireless network may be determined based on the monitored resource grants.

In some examples of the method, apparatus, or non-transitory computer-readable medium described above, determining the channel conditions associated with the uplink of the wireless network may include estimating an uplink throughput of the wireless network, wherein the format of the media content may be dynamically adjusted to match a streaming bandwidth of the media content to the estimated uplink throughput of the wireless network.

In some examples of the method, apparatus, or non-transitory computer-readable medium described above, determining the channel conditions associated with the uplink of the wireless network may include receiving channel state information (CSI) for the uplink from the wireless network, where the determined channel conditions are based on the CSI.

Some examples of the method, apparatus, or non-transitory computer-readable medium described above may further include processes, features, means, or instructions for storing the media content on the wireless device in a first format and streaming the media content from the wireless device over the wireless network in a second format based on the determined channel conditions or the determined loading parameter.

Some examples of the method, apparatus, or non-transitory computer-readable medium described above may further include processes, features, means, or instructions for selecting a subset of the media content to stream over the wireless network based on the determined channel conditions or the determined loading parameter.

In some examples of the method, apparatus, or non-transitory computer-readable medium described above, dynamically adjusting the format of the media content may include dynamically adjusting an encoding of the media content.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates an example of a wireless communication system, in accordance with various aspects of the disclosure;

FIG. 2 illustrates an example of a wireless communication system, in accordance with various aspects of the disclosure;

FIG. 3 illustrates an ad-hoc wireless connection between two wireless devices;

FIG. 4 shows a block diagram of a wireless device for use in wireless communication, in accordance with various embodiments;

FIG. 5 shows a block diagram of a wireless device for use in wireless communication, in accordance with various embodiments;

FIG. 6 shows a block diagram of a wireless device for use in wireless communication, in accordance with various embodiments;

FIG. 7 shows a block diagram of a wireless device for use in wireless communication, in accordance with various embodiments;

FIG. 8 shows a block diagram of a wireless device for use in wireless communication, in accordance with various embodiments;

FIG. 9 is a flow chart illustrating an example of a method for wireless communication, in accordance with various embodiments;

FIG. 10 is a flow chart illustrating an example of a method for wireless communication, in accordance with various embodiments;

FIG. 11 is a flow chart illustrating an example of a method for wireless communication, in accordance with various embodiments; and

FIG. 12 is a flow chart illustrating an example of a method for wireless communication, in accordance with various embodiments.

### DETAILED DESCRIPTION

Given the current popularity of sharing media content (e.g., audio, images, and/or video), it would be desirable to expand the conditions under which media content may be wirelessly shared or streamed. Techniques that may accomplish these or other purposes are described herein. In some embodiments, the techniques may provide for dynamically adjusting the streaming of media content from a wireless device. The dynamic adjustments may in some cases be based on channel conditions and/or a loading of a cell of a wireless network. In some embodiments, the techniques may provide for delaying the streaming of media content from a wireless device, or for selecting a subset of media content for streaming. In some embodiments, the techniques may enable a second wireless device to connect to a first wireless device over an ad-hoc wireless connection, and to dynamically control the capture or streaming of media content at the first wireless device. As used herein, the terms “streamed” or “streaming” may include any streaming or upload of media content from a device, including real-time or near real-time uploads of photos, a series of photos, video, or audio.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

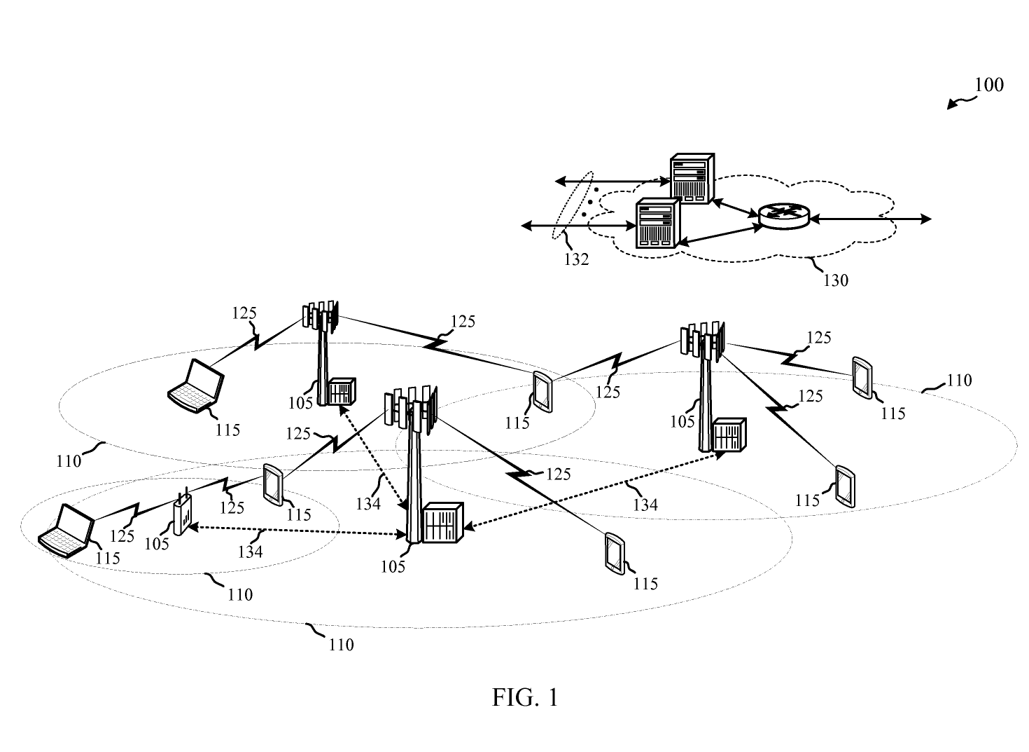

FIG. 1 illustrates an example of a wireless communication system 100, in accordance with various aspects of the disclosure. The wireless communication system 100 includes base stations 105, UEs (e.g., wireless devices) 115, and a core network 130. The core network 130 may provide user authentication, access authorization, tracking, Internet Protocol (IP) connectivity, and other access, routing, or mobility functions. The base stations 105 interface with the core network 130 through backhaul links 132 (e.g., S1, etc.) and may perform radio configuration and scheduling for communication with the UEs 115, or may operate under the control of a base station controller (not shown). In various examples, the base stations 105 may communicate, either directly or indirectly (e.g., through core network 130), with each other over backhaul links 134 (e.g., X1, etc.), which may be wired or wireless communication links.

The base stations 105 may wirelessly communicate with the UEs 115 via one or more base station antennas. Each of the base station 105 sites may provide communication coverage for a respective geographic coverage area 110. In some examples, base stations 105 may be referred to as a base transceiver station, a radio base station, an access point, a radio transceiver, a NodeB, eNodeB (eNB), Home NodeB, a Home eNodeB, or some other suitable terminology. The geographic coverage area 110 for a base station 105 may be divided into sectors making up only a portion of the coverage area (not shown). The wireless communication system 100 may include base stations 105 of different types (e.g., macro and/or small cell base stations). There may be overlapping geographic coverage areas 110 for different technologies.

In some examples, the wireless communication system 100 may be or include an LTE/LTE-A network. In LTE/LTE-A networks, the term evolved Node B (eNB) may be generally used to describe the base stations 105, while the term UE may be generally used to describe the UEs 115. The wireless communication system 100 may be a Heterogeneous LTE/LTE-A network in which different types of eNBs provide coverage for various geographical regions. For example, each eNB or base station 105 may provide communication coverage for a macro cell, a small cell, and/or other types of cell. The term “cell” is a 3GPP term that can be used to describe a base station, a carrier or component carrier associated with a base station, or a coverage area (e.g., sector, etc.) of a carrier or base station, depending on context.

A macro cell generally covers a relatively large geographic area (e.g., several kilometers in radius) and may allow unrestricted access by UEs with service subscriptions with the network provider. A small cell is a lower-powered base station, as compared with a macro cell, that may operate in the same or different (e.g., licensed, unlicensed, etc.) frequency bands as macro cells. Small cells may include pico cells, femto cells, and micro cells according to various examples. A pico cell may cover a relatively smaller geographic area and may allow unrestricted access by UEs with service subscriptions with the network provider. A femto cell also may cover a relatively small geographic area (e.g., a home) and may provide restricted access by UEs having an association with the femto cell (e.g., UEs in a closed subscriber group (CSG), UEs for users in the home, and the like). An eNB for a macro cell may be referred to as a macro eNB. An eNB for a small cell may be referred to as a small cell eNB, a pico eNB, a femto eNB or a home eNB. An eNB may support one or multiple (e.g., two, three, four, and the like) cells (e.g., component carriers).

The wireless communication system 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

The communication networks that may accommodate some of the various disclosed examples may be packet-based networks that operate according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use Hybrid ARQ (HARQ) to provide retransmission at the MAC layer to improve link efficiency. In the control plane, the Radio Resource Control (RRC) protocol layer may provide establishment, configuration, and maintenance of an RRC connection between a UE 115 and the base stations 105 or core network 130 supporting radio bearers for the user plane data. At the Physical (PHY) layer, the transport channels may be mapped to Physical channels.

The UEs 115 may be dispersed throughout the wireless communication system 100, and each UE 115 may be stationary or mobile. A UE 115 may also include or be referred to by those skilled in the art as a mobile station, a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or some other suitable terminology. A UE 115 may be a cellular phone, a camera (e.g., a video camera and/or a still camera), a personal digital assistant (PDA), a wireless modem, a wireless communication device, a handheld device, a tablet computer, a laptop computer, a cordless phone, a wireless local loop (WLL) station, or the like. A UE may be able to communicate with various types of base stations and network equipment including macro eNBs, small cell eNBs, relay base stations, and the like.

The communication links 125 shown in the wireless communication system 100 may include uplink (UL) transmissions from a UE 115 to a base station 105, and/or downlink (DL) transmissions, from a base station 105 to a UE 115. The downlink transmissions may also be called forward link transmissions while the uplink transmissions may also be called reverse link transmissions. Each communication link 125 may include one or more carriers, where each carrier may be a signal made up of multiple sub-carriers (e.g., waveform signals of different frequencies) modulated according to the various radio technologies described above. Each modulated signal may be sent on a different sub-carrier and may carry control information (e.g., reference signals, control channels, etc.), overhead information, user data, etc. The communication links 125 may transmit bidirectional communications using FDD (e.g., using paired spectrum resources) or TDD operation (e.g., using unpaired spectrum resources). Frame structures for FDD (e.g., frame structure type 1) and TDD (e.g., frame structure type 2) may be defined.

In some embodiments of the wireless communication system 100, base stations 105 and/or UEs 115 may include multiple antennas for employing antenna diversity schemes to improve communication quality and reliability between base stations 105 and UEs 115. Additionally or alternatively, base stations 105 and/or UEs 115 may employ multiple-input, multiple-output (MIMO) techniques that may take advantage of multi-path environments to transmit multiple spatial layers carrying the same or different coded data.

As a UE 115 moves within the wireless communication system 100 (and even at different times while operating at the same location), the UE 115 may move experience different channel conditions at different locations within the wireless communication system 100. When less than optimum or poor channel conditions affect an uplink channel of the UE 115, the UE 115 may experience difficulty when streaming media content to a base station 105 (e.g., for real-time viewing, for purposes of storing the media content at a remote location, such as on a server, or for purposes of sharing the media content with other devices). Changes in the loading of a cell of the wireless communication system 100, or differences in the loading of different cells that a UE 115 may be handed over to as it moves within the wireless communication system 100, may also affect the UE's streaming of media content to a base station 105. The UE may adjust the media content's format based on channel conditions or a loading parameter of the cell of the wireless network. When the wireless communication system includes devices (e.g., base stations 105 or wireless access points) that operate using different radio access technologies (RATs), the different RATs may also impact a UE's ability to stream media content.

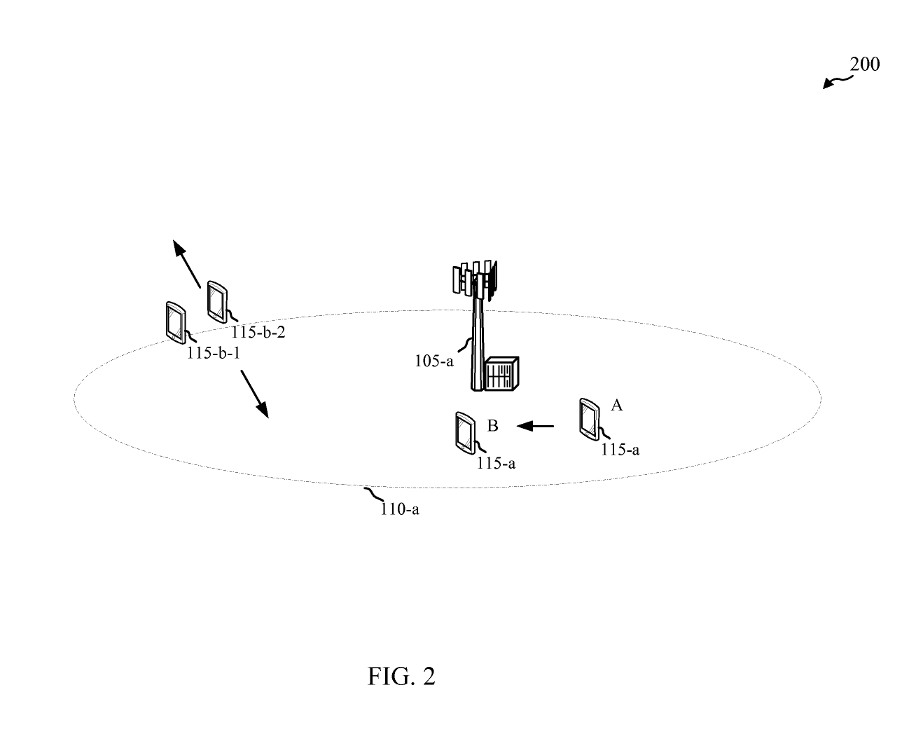

FIG. 2 illustrates an example of a wireless communication system 200, in accordance with various aspects of the disclosure. By way of example, the wireless communication system 200 may include a base station 105-a and a number of UEs 115-a, 115-b-1, and/or 115-b-2. The wireless communication system 200 may be an example of part of the wireless communication system 100 described with reference to FIG. 1, and the base station 105-a and UEs 115-a, 115-b, and 115-c may be examples of the base stations 105 and UEs 115 described with reference to FIG. 1.

As a UE 115-a moves from one location to another (e.g., from location A to location B) within the coverage area 110-a of the base station 105-a, the UE 115-a may experience different channel conditions. In some cases, the different channel conditions may be experienced because one location is closer or farther from the base station 105-a, or because the path between the base station 105-a and the UE 115-a is obstructed (e.g., by land formations, building walls, etc.). In some cases, the different channel conditions may be experienced because of a difference in altitude between the two locations (e.g., location A may be at the top of a ski slope and location B may be at the bottom of the ski slope). In some cases, channel conditions experienced by the UE 115-a may change even when the UE 115-a does not move.

When the UE 115-a is capable of capturing media content (e.g., audio and/or video), a user of the UE 115-a may want to stream the media content to another device (e.g., a broadcast, a friend's UE, a display in a conference room, etc.). When the UE 115-a is being moved from location A to location B (e.g., because a user of the UE is jogging, cycling, skiing, walking, etc.), or when the UE 115-a otherwise experiences changing channel conditions, streaming audio and/or video and/or a sequence of photo uploads may be interrupted. However, by dynamically adjusting a format of media content streaming from the UE 115-a, the UE 115-a may be able to continue streaming the media content. Also, or alternatively, delaying the streaming or selecting a subset of media content for upload may better enable continuous streaming. Alternatively, delaying the streaming may enable the streaming of operation of a desired minimum quality.

Factors other than changing channel conditions may also impact a UE's streaming of media content. For example, changes in loading of a cell of the wireless communication system 200 may affect the streaming operation. The loading of a cell may change as UEs, such as the UE 115-b-1 and/or the UE 115-b-2, enter or leave the coverage area 110-a of the base station 105-a. The UE 115-a may determine a loading parameter based on the loading of the cell of the wireless communication system 200. For example, the UE 115-a may determine the loading parameter based on a quality of service (QoS) grant from the cell, as received from the base station 105-a. The QoS grant may be UE-initiated or network-initiated.

In the case of a UE-initiated QoS grant, the UE 115-a may communicate with the base station 105-a to request an uplink QoS grant to stream the media content. The requested uplink QoS grant may include a requested uplink bit rate for streaming the media content. In response to the request, the UE 115-a may receive a QoS grant from the base station 105-a. The QoS request and subsequent grant may be part of a process for setting up an uplink radio bearer for the connection carrying the media content to be streamed by the UE 115-a. The QoS grant may include a maximum bit rate (MBR) supported by the base station for the streaming of the media content, a guaranteed bit rate (GBR) supported by the base station 105-a for the streaming of the media content, or a combination or derivative of these parameters. The QoS grant received from the base station 105-a may be used as a basis for determining a loading parameter; in other words, the QoS grant may indicate a loading condition at the cell of the base station 105-a. For example, if the GBR granted to the UE 115-a is less than the QoS requested by the UE 115-a, the UE 115-a may infer that the cell of the base station 105-a is experiencing loading or congestion that prevents the network from supporting the requested QoS. In some cases, a threshold may be defined such that the loading parameter indicative of a congested network is determined if the GBR granted by the base station 105-a is lower than the requested QoS by at least the defined threshold. Different thresholds may be defined across different networks or for different UEs. The threshold used by the UE 115-a may be predefined based on historical or predicted correlation between network congestion and QoS grants. The loading parameter may be a simple binary parameter (i.e. congested vs. uncongested) or may be indicative of multiple levels of loading or congestion.

In the case of a network-initiated QoS grant, the base station 105-a may grant a QoS to the UE for uplink media content streaming based on communications between the core network and a third-party application server or an individual user (e.g., an operator of a UE 115). For example, the third-party application server may communicate with the UE 115-a and/or an individual user to determine that the UE 115-a has uplink media content to stream. The third-party application server may then communicate with a policy and charging rules function (PCRF) or similar entity of the core network to confirm that the UE 115-a is authorized to stream the uplink media content and request a QoS for the UE 115-a to stream the media content. The PCRF or similar entity of the core network may then select a QoS to be granted to the UE 115-a based on the request from the third-party application server and a maximum QoS that the network can support for the UE 115-a based on congestion and/or loading at the base station 105-a or core network. The QoS may be requested and granted in the form of a GBR or MBR for the streaming of the media content, as discussed above. The base station 105-a may grant the selected QoS to the UE 115-a, for example, during the configuration of a radio bearer. As in the UE-initiated case, the QoS granted to the UE may be indicative of loading or congestion on the network side. While in this case the UE 115-a may not necessarily know what specific QoS was requested for the UE 115-a by the third-party application server, the UE 115-a may determine a loading parameter for the cell of the base station 105-a by comparing a nominal bit rate for streaming the uplink media content to the GBR granted to the UE 115-a. As in the UE-initiated case, a threshold may be defined such that the network is considered to be loaded or congested if the GBR granted by the base station 105-a is lower than the nominal bit rate for streaming the uplink media content by at least the defined threshold.

In addition to or instead of a QoS grant from the base station 105-a, the UE 115-a may also use an actual QoS supported by the base station 105-a to determine the loading parameter. The actual QoS provided by the base station 105-a may be determined based on an observation over time of uplink scheduling grants provided to the UE 115-a. Based on the number of resource blocks allocated to the UE 115-a in each scheduling grant, the modulation and coding scheme used by the UE 115-a, and the frequency of scheduling grants, the UE 115-a can determine the actual QoS provided by the base station 105-a in the form of an actual uplink bit rate for the streaming of the uplink media content. If the actual uplink bit rate supported by the base station 105-a dips below a GBR specified by the base station 105-a or a nominal bit rate for streaming the uplink media content, the cell, base station 105-a, or core network may be considered to be congested or loaded. In some cases, a determination of congestion may be based on a threshold value; in other words, a determination of congestion may be predicated on the actual uplink bit rate falling below the GBR or the nominal bit rate for streaming the uplink media content by at least a predefined threshold. In some cases, a time-based threshold may also be used such that a determination of congestion is predicated on the actual uplink bit rate falling below the GBR or the nominal bit rate for at least a predefined period of time.

An additional way the UE 115-a may determine a loading parameter for a cell is by monitoring control channels broadcast by the base station 105-a of the cell. For example, the UE 115-a may monitor a physical downlink control channel (PDCCH) in subframes transmitted by the base station 105-a to determine a) how many other UEs in the cell are receiving uplink and downlink grants at a given time and b) the number of resource blocks being assigned to each UE for these grants. If the number of UEs receiving grants in the cell is greater than a predefined threshold or an average number of resource blocks being granted to each UE is lower than a threshold, the UE 115-a can infer that a loading or congestion condition exists at the network. In some cases, the determined loading parameter may be further based on time of day or another environmental factor. For example, the threshold number of UEs in the cell or average number of resource blocks in each grant may be different for a cell at different times of the day to account for predictable time-based surges in traffic.

The UE 115-a may delay streaming the media content over the wireless network until channel conditions improve or the loading of the cell improves.

Furthermore, the UE 115-a may adjust a format of media content streaming from the UE 115-a based on channel conditions or the loading of the network or cell. If the UE 115-a receives an indication that the network or cell is overloaded, the UE 115-a may dynamically adapt its streamed media as loading/congestion increases or decreases. For example, the UE 115-a may change the media's file format, such as switching between formats with different amounts of lossiness or compression (i.e. different streaming bit rates). The UE 115-a may also change the file type of the streamed media content. For example, changing the file type may include switching from a movie to a series of still images. In some cases, the decision to change the media's file format or file type may involve communicating with a third-party application server to request a different file format, file type, or time of transmission. The third-party application server may accordingly request an updated QoS or cancel a request for QoS from the core network.

By dynamically adjusting the format or file type of media content streaming from the UE 115-a based on the loading of a cell (e.g., the loading of the base station 105-a), or based on differences in the loading of different cells as the UE 115-a is handed over from one cell to another, the streaming of media content from the UE 115-a may continue despite the changes in loading. If network conditions do not improve, the UE 115-a may choose to cancel or postpone uplink transmission of the media until network conditions improve.

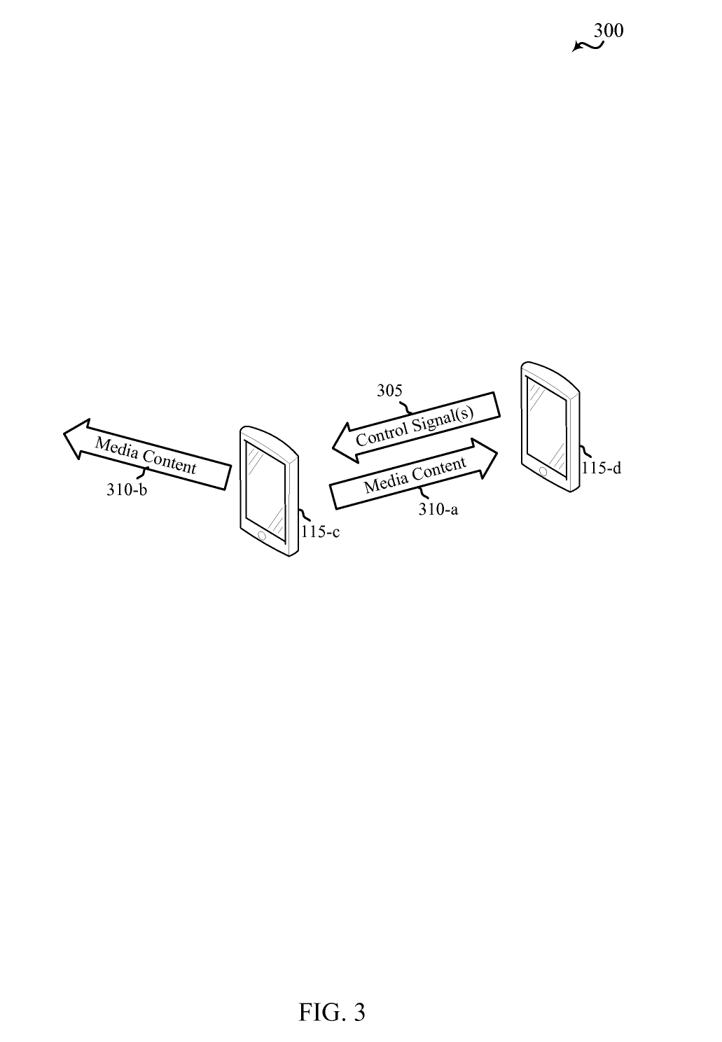

FIG. 3 illustrates an ad-hoc wireless connection 300 between two wireless devices (e.g., a first UE 115-c and a second UE 115-d), in accordance with various aspects of the disclosure. The first UEs 115-c and second 115-d may be examples of the UEs 115 described with reference to FIGS. 1 and/or 2.

In some embodiments, the first UE 115-c may be capable of streaming media content to another device. The first UE 115-c may also be capable of capturing media content. In some examples, a user of the first UE 115-c may also be capable of using the first UE 115-c to capture and/or upload/stream media content in real-time and/or hands-free (e.g., the first UE 115-c may be strapped to or otherwise mounted on the user's head, arm, bicycle, ski, etc.). However, when using the first UE 115-c in a hands-free mode of operation, the first UE 115-c may not be oriented in an optimum or desired direction for acquiring media content, or may not be set to an optimum or desired zoom. Under these and other scenarios, it may be desirable if another person and/or device could dynamically control the camera. For example, it might be desirable if another person and/or device could dynamically adjust the orientation and/or zoom of the UE's camera, or adjust the recording level of the UE's microphone, or adjust the capture rate of a succession of images via the UE's camera.

As shown in FIG. 3, a user of the second UE 115-d may use the second UE 115-d to send one or more control signals 305 to the first UE 115-c. In some examples, the control signals 305 may be transmitted from the second UE 115-d to the first UE 115-c over an ad-hoc wireless connection established between the first UE 115-c and the second UE 115-d. Establishment of the ad-hoc wireless connection may in some cases be initiated by the first UE 115-c or the second UE 115-d. In some examples, a technology such as AllJoyn™ may be used to advertise that the first UE 115-c is capable of being controlled and/or monitored by other wireless devices in its vicinity.

The second UE 115-d may not only control the first UE 115-c, but may receive media content 310 (e.g., media content 310-a) from the first UE 115-c. In some examples, the media content 310-a may be transmitted from the first UE 115-c to the second UE 115-d over the ad-hoc wireless connection between the first UE 115-c and the second UE 115-d. In other examples, the media content 310-a may be transmitted from the first UE 115-c to the second UE 115-d over some other wireless network. The media content 310 (e.g., media content 310-b) may also or alternatively be transmitted to one or more other devices. In some examples, the second UE 115-d may select the devices to which the media content 310 is streaming. The second UE 115-d may also control how or when the media content 310 is streaming, or choose and/or filter what media content is streaming.

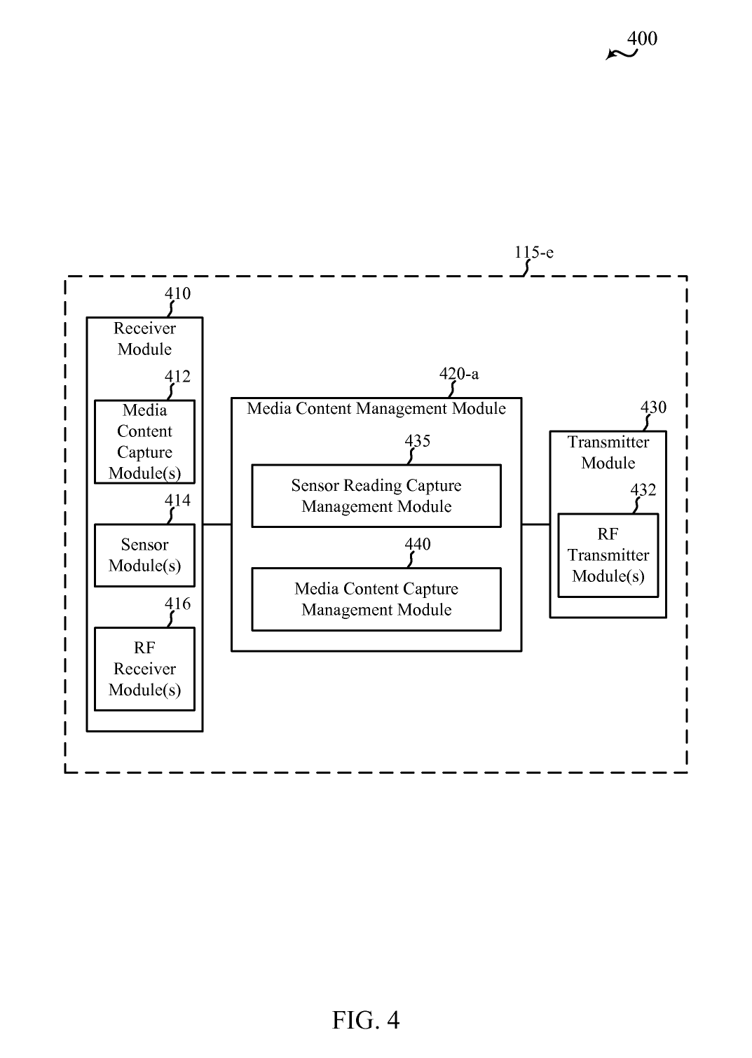

FIG. 4 shows a block diagram 400 of a wireless device 115-e for use in wireless communication, in accordance with various embodiments. In some examples, the wireless device 115-e may be an example of aspects of one of the wireless devices 115 described with reference to FIGS. 1, 2, and/or 3. The wireless device 115-e may also be a processor. The wireless device 115-e may include a receiver module 410, a media content management module 420-a, and/or a transmitter module 430. Each of these components may be in communication with each other.

The components of the wireless device 115-e may, individually or collectively, be implemented using one or more application-specific integrated circuits (ASICs) adapted to perform some or all of the applicable functions in hardware. Alternatively, the functions may be performed by one or more other processing units (or cores), on one or more integrated circuits. In other examples, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors.

In some examples, the receiver module 410 may include one or more media content capture modules (e.g., media content capture module(s) 412). The media content capture module(s) 412 may include, for example, a camera (e.g., a video or still camera including an image sensor, such as a complimentary metal-oxide semiconductor (CMOS) image sensor) and/or a microphone. The receiver module 410 may also include one or more sensor modules (e.g., sensor module(s) 414). The sensor module(s) may include, for example, one or more of a geographic location sensor (e.g., a global positioning sensor (GPS)), a motion sensor, an accelerometer, a barometer, an audio sensor, and/or a biometric sensor (e.g., a pulse sensor and/or bioelectric impedance sensor). The receiver module 410 may also include one or more radio frequency (RF) receiver modules (e.g., RF receiver module(s) 416), such as a wireless local area network (WLAN) receiver module (e.g., a Wi-Fi receiver module), a wireless wide area network (WWAN) receiver module (e.g., a cellular receiver module such as an LTE/LTE-A receiver module), a Bluetooth (BT) receiver module, and/or a BT Low Energy (BTLE) receiver module). The RF receiver module(s) 416 may be used to receive, for example, various types of data and/or control signals (i.e., transmissions) over one or more communication links of one or more wireless communication systems. In some examples, the RF receiver module(s) 416 may be used to receive, over a wireless network and/or an ad-hoc wireless connection, one or more control signals related to media content capture and streaming.

In some examples, the transmitter module 430 may include one or more RF transmitter modules (e.g., RF transmitter module(s) 432), such as a WLAN transmitter module (e.g., a Wi-Fi transmitter module), a WWAN transmitter module (e.g., a cellular transmitter module such as an LTE/LTE-A transmitter module), a BT transmitter module, and/or a BTLE transmitter module. The RF transmitter module(s) 432 may be used to transmit, for example, various types of data and/or control signals (i.e., transmissions) over one or more communication links of one or more wireless communication systems. In some examples, the RF transmitter module(s) 432 may be used to transmit, over a wireless network or ad-hoc wireless connection, media content captured or stored by the wireless device 115-e.

The media content management module 420-a may be used to manage various functions related to media content capture and streaming. The media content management module 420-a may include a sensor reading capture management module 435 and a media content capture management module 440.

In some examples, the sensor reading capture management module 435 may be used to capture sensor readings from one or more of the sensor module(s) 414. The sensor readings may include, for example, geographic location, speed, altitude, sound level, pulse, and/or bioelectric impedance. In some examples, the sensor readings may be captured and correlated with the capture of media real-time media content.

The media content capture management module 440 may be used to manage the capture of media content via one or more of the media content capture module(s) 412. In some examples, the media content capture management module 440 may store captured media content on the wireless device 115-e in a default format, in a storage-optimized format (e.g., a format based on the available storage on the wireless device 115-e), or in a user-selected format.

In one example, the media content capture management module 440 may trigger a commencement of media content capture, via one or more of the media content capture module(s) 412, upon reaching or entering a starting location or altitude, as indicated by a first reading acquired from a location sensor, altitude sensor, accelerometer, or motion sensor; or the media content capture management module 440 may trigger a conclusion of media content capture upon reaching or entering an ending location or altitude, as indicated by a second reading acquired from the location sensor, altitude sensor, accelerometer, or motion sensor. The media content capture may include, for example, photo or video capture in real-time. For example, media content may be captured hands-free on a ski slope, beginning when a user of the wireless device 115-e reaches a top of a ski run, and ending when the user reaches a bottom of the ski run.

In another example, the media content capture management module 440 may trigger a commencement of media content capture, via one or more of the media content capture module(s) 412, upon a commencement of bursty audio commentary (e.g., talking by a user of the wireless device 115-e), as indicated by a first reading acquired from an audio sensor; and/or the media content capture management module 440 may trigger a conclusion of media content capture upon an end of bursty audio commentary, as indicated by a second reading acquired from the audio sensor. The media content capture may include, for example, photo or video capture in real-time.

In another example, the media content capture management module 440 may trigger a commencement of media content capture, via one or more of the media content capture module(s) 412, upon an occurrence of a biometric condition or conditions (e.g., a biometric condition or conditions indicating high stress), as indicated by a first reading acquired from one or more biometric sensors. The media content capture management module 440 may trigger a conclusion of media content capture upon an end of the biometric condition or conditions, as indicated by a second reading acquired from the one or more biometric sensors. The media content capture may include, for example, photo or video capture in real-time. Also or alternatively, a capture of biometric readings may be triggered upon the capture of media content so that, for example, media content (e.g., video footage) captured during performance training (e.g., a high stress scenario, as indicated by the biometric readings) may be compared to media content captured under normal conditions (e.g., a low stress scenario, as indicated by the biometric readings).

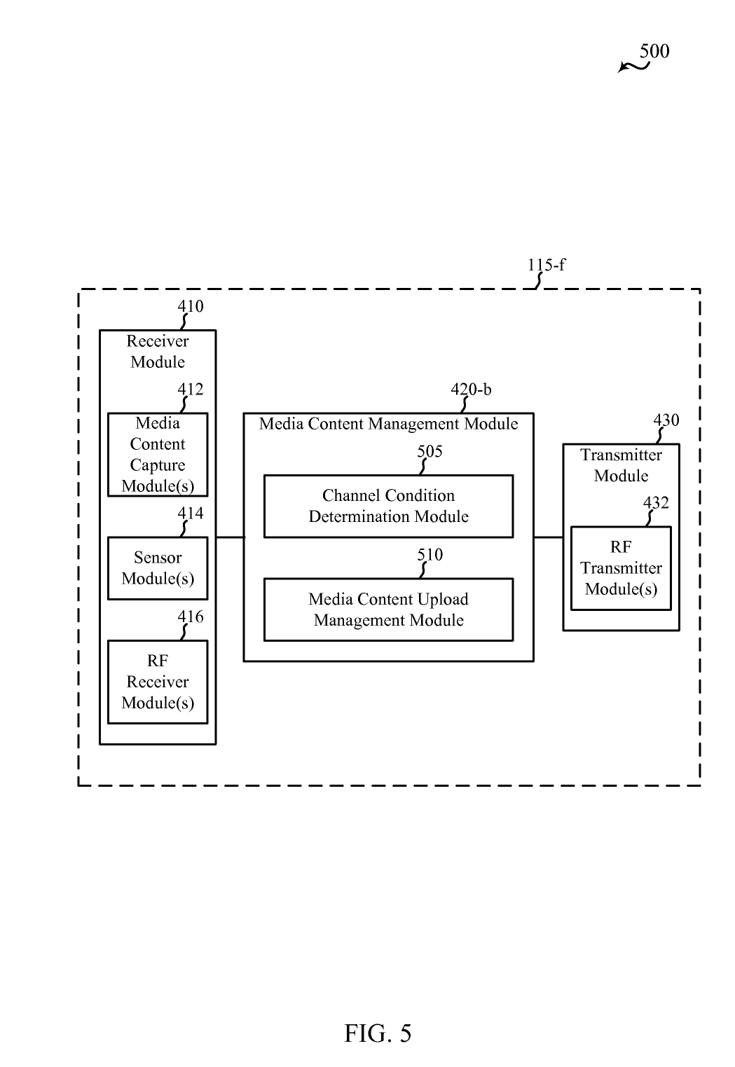

FIG. 5 shows a block diagram 500 of a wireless device 115-f for use in wireless communication, in accordance with various embodiments. In some examples, the wireless device 115-f may be an example of aspects of one of the wireless devices 115 described with reference to FIGS. 1, 2, 3, and/or 4. The wireless device 115-f may also be a processor. The wireless device 115-f may include a receiver module 410, a media content management module 420-b, and/or a transmitter module 430. Each of these components may be in communication with each other.

The components of the wireless device 115-f may, individually or collectively, be implemented using one or more ASICs adapted to perform some or all of the applicable functions in hardware. Alternatively, the functions may be performed by one or more other processing units (or cores), on one or more integrated circuits. In other examples, other types of integrated circuits may be used (e.g., Structured/Platform ASICs, FPGAs, and other Semi-Custom ICs), which may be programmed in any manner known in the art. The functions of each unit may also be implemented, in whole or in part, with instructions embodied in a memory, formatted to be executed by one or more general or application-specific processors.

In some examples, the receiver module 410 and transmitter module 430 may be configured as described with reference to FIG. 4. The receiver module 410 may include, for example, one or more media content capture module(s) 412, one or more sensor module(s) 414, and one or more RF receiver module(s) 416. The transmitter module 430 may include, for example, one or more RF transmitter module(s) 432.

The media content management module 420-b may be used to manage various functions related to media content capture and streaming. In some examples, the media content management module 420-b may be an example of the media content management module 420 described with reference to FIG. 4. In some examples, the media content management module 420-b may include a channel condition determination module 505 and a media content upload management module 510.

In some examples, the channel condition determination module 505 may be used to determine channel conditions associated with an uplink of a wireless network. In some examples, determining the channel conditions associated with the uplink of the wireless network may include receiving channel state information (CSI) for the uplink from the wireless network, and determining the channel conditions based on the CSI. In some examples, determining the channel conditions associated with the uplink of the wireless network may include estimating an uplink throughput of the wireless network. In some examples, the uplink throughput of the wireless network may be estimated based on a radio access technology (RAT) (e.g., LTE, LTE-A, HSPA, HSPA+, EVDO, Wi-Fi, etc.) of the wireless network, an uplink channel quality of the wireless network, or a combination thereof.

The media content upload management module 510 may be used to dynamically adjust a format of media content streaming from the wireless device 115-f over the wireless network based on the channel conditions determined by the channel condition determination module 505. In some examples, dynamically adjusting the format of the media content may include dynamically adjusting the streaming bandwidth of the media content to match the estimated uplink throughput of the wireless network. In some examples, dynamically adjusting the format of the media content may also or alternatively include dynamically adjusting an encoding of the media content. In a video streaming context, dynamically adjusting the format of a video stream may include, for example, adjusting the video stream to a 1080p, 720p, or 480 lines per inch video quality.

The media content upload management module 510 may adapt the streaming of media content for the purpose of increasing the likelihood that the streaming continues without interruption or degradation, or for the purpose of ensuring that the streaming is of a desired minimum quality, or to ease the processing burden on the wireless device 115-f.

In some examples, the wireless network over which media content is streaming may be a WWAN, and the media content may be streamed over an IMS of the WWAN. In some examples, the wireless network over which media content is streaming may be a WLAN.

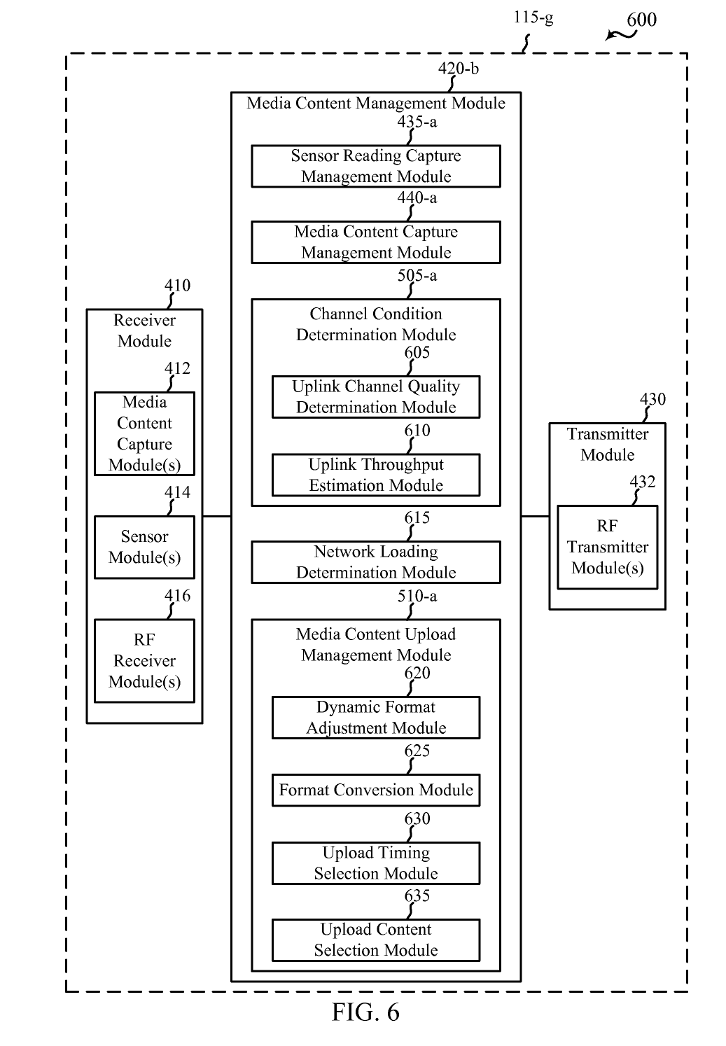

FIG. 6 shows a block diagram 600 of a wireless device 115-g for use in wireless communication, in accordance with various embodiments. The wireless device 115-g may be an example of one of the wireless devices 115 described with reference to FIGS. 1, 2, 3, 4, and/or 5. The wireless device 115-g may also be a processor. The wireless device 115-g may include a receiver module 410, a media content management module 420-c, and/or a transmitter module 430. Each of these components may be in communication with each other.

The components of the wireless device 115-g may, individually or collectively, be implemented using one or more ASICs adapted to perform some or all of the applicable functions in hardware. Alternatively, the functions may be performed by one or more other processing units (or cores), on one or more integrated circuits. In other examples, other types of integrated circuits may be used (e.g., Structured/Platform ASICs, FPGAs, and other Semi-Custom ICs), which may be programmed in any manner known in the art. The functions of each unit may also be implemented, in whole or in part, with instructions embodied in a memory, formatted to be executed by one or more general or application-specific processors.

In some examples, the receiver module 410, or transmitter module 430 may be configured as described with reference to FIG. 4. The receiver module 410 may include, for example, one or more media content capture module(s) 412, one or more sensor module(s) 414, and one or more RF receiver module(s) 416. The transmitter module 430 may include, for example, one or more RF transmitter module(s) 432.

The media content management module 420-c may be used to manage various functions related to media content capture and streaming. The media content management module 420-c may be an example of the media content management module 420 described with reference to FIGS. 4 and/or 5. In some examples, the media content management module 420-c may include a sensor reading capture management module 435-a, a media content capture management module 440-a, a channel condition determination module 505-a, a network loading determination module 615, and a media content upload management module 510-a.

The sensor reading capture management module 435-a and the media content capture management module 440-a may be configured as described with reference to FIG. 4. The media content capture management module 440-a may be further or alternatively used to store media content on the wireless device 115-g in a first format. The first format may be a user-selected format, a native or raw format, or a high-resolution format. The first format may be suitable for streaming from the wireless device 115-g over a wired or Wi-Fi connection.

The channel condition determination module 505-a may be used to determine channel conditions associated with an uplink of a wireless network. The channel condition determination module 505-a may include an uplink channel quality determination module 605 and an uplink throughput estimation module 610. In some examples, the uplink channel quality determination module 605 may be used to receive or determine CSI for the uplink from the wireless network. Also or alternatively, the uplink channel quality determination module 605 may be used to receive or determine a signal-to-noise ratio (SNR) or reference signal received power (RSRP) for the channel. The channel condition determination module 505-a may then determine the channel conditions associated with the uplink based on the CSI, SNR, or RSRP. In some examples, the uplink throughput estimation module 610 may be used to estimate an uplink throughput of the wireless network. In some examples, the uplink throughput of the wireless network may be estimated based on a RAT (e.g., LTE, LTE-A, HSPA, HSPA+, EVDO, Wi-Fi, etc.) of the wireless network, an uplink channel quality of the wireless network (e.g., as received or determined by the uplink channel quality determination module 605), or a combination thereof.

The network loading determination module 615 may be used to determine a loading of a cell of the wireless network (e.g., unloaded, loaded, and/or a level of loading). The loading of the cell may be based on a QoS grant received by the wireless device 115-g, monitored control channels broadcast by a base station of the cell, or other parameters, as described above.

The media content upload management module 510-a may be used to manage the streaming of media content from the wireless device 115-g. The media content upload management module 510-a may be an example of the media content upload management module 510 described with reference to FIG. 5. In some examples, the media content upload management module 510-a may include a dynamic format adjustment module 620, a format conversion module 625, an upload timing selection module 630, and an upload content selection module 635.

The dynamic format adjustment module 620 may be used to dynamically adjust a format of media content streaming from the wireless device 115-g over a wireless network based on channel conditions, as determined by the channel condition determination module 505-a. The format of the media content streamed from the wireless device 115-g may also or alternatively be dynamically adjusted based on a loading of a cell of the wireless network, as determined by the network loading determination module 615. The format of the media content streamed from the wireless device 115-g may also or alternatively be dynamically adjusted based on a type of wireless network over which the media content is being streamed (e.g., based on a RAT of the wireless network, such as LTE, LTE-A, HSPA, HSPA+, EVDO, Wi-Fi, etc.). In some examples, dynamically adjusting the format of the media content may include dynamically adjusting the streaming bandwidth of the media content to match an estimated uplink throughput of the wireless network, as determined by the uplink throughput estimation module 610. In some examples, dynamically adjusting the format of the media content may also or alternatively include dynamically adjusting an encoding of the media content. In a video streaming context, dynamically adjusting the format of a video stream may include, for example, adjusting the video stream to a 1080p, 720p, or 480 lines per inch video quality.

In some examples, the format conversion module 625 may be used to convert media content captured or stored at the wireless device 115-g in a first format to a second format, which second format may be used to stream the media content from the wireless device 115-g. The second format may differ from the first format and may be selected based on channel conditions determined by the channel condition determination module 505-a or a loading of a cell of a wireless network determined by the network loading determination module 615. For example, the media format may be converted between formats with different amounts of lossiness or compression (i.e. different streaming bit rates). In some cases, the media file format may be changed, such as changing from a movie to a series of still photographs.

The upload timing selection module 630 may be used to select a time to or stream media content captured or stored at the wireless device 115-g over a wireless network. The time may be selected based on channel conditions determined by the channel condition determination module 505-a and/or a loading of a cell of a wireless network determined by the network loading determination module 615. In some examples, selecting a time to stream media content may include delaying streaming the media content over a wireless network until a CSI parameter for an uplink improves.

The upload content selection module 635 may be used to select a subset of media content captured or stored at the wireless device 115-g for streaming over the wireless network. The subset of media content may be selected based on channel conditions determined by the channel condition determination module 505-a or a loading of a cell of the wireless network determined by the network loading determination module 615.

The media content upload management module 510-a may be used to manage the streaming of media content from the wireless device 115-g over a wireless network based on a trigger. In some examples, the media content upload management module 510-a may begin streaming media content based on a commencement of media content capture via one or more of the media content capture module(s) 412. In some examples, the media content upload management module 510-a may begin streaming media content based on reaching or entering a starting location or altitude, as indicated by a first reading acquired from a location sensor, altitude sensor, accelerometer, or motion sensor, or, the media content upload management module 510-a may conclude or pause the streaming of media content upon reaching or entering an ending location or altitude, as indicated by a second reading acquired from the location sensor, altitude sensor, accelerometer, and/or motion sensor.

In some examples, the media content upload management module 510-a may stream media content from the wireless device 115-g in real-time or hands-free. For example, media content may be captured and streamed hands-free on a ski slope, beginning when a user of the wireless device 115-g reaches a top of a ski run, and ending when the user reaches a bottom of the ski run.

The media content upload management module 510-a may be used to capture and stream media content upon a commencement of bursty audio commentary (e.g., talking by a user of the wireless device 115-g), as indicated by a first reading acquired from an audio sensor; and/or the media content upload management module 510-a may trigger a conclusion of media content capture and streaming upon an end of bursty audio commentary, as indicated by a second reading acquired from the audio sensor. The media content capture and upload may include, for example, photo and/or video capture/streaming in real-time.

In some examples, the media content upload management module 510-a may be used to capture and stream media content upon an occurrence of a biometric condition or conditions (e.g., a biometric condition or conditions indicating high stress), as indicated by a first reading acquired from one or more biometric sensors; and/or the media content upload management module 510-a may trigger a conclusion of media content capture and streaming upon an end of the biometric condition or conditions, as indicated by a second reading acquired from the one or more biometric sensors. The media content capture and streaming may include, for example, photo and/or video capture/streaming in real-time. Also or alternatively, biometric readings may be captured and uploaded with the media content so that, for example, media content (e.g., video footage) captured during performance training (e.g., a high stress scenario, as indicated by the biometric readings) may be compared to media content captured under normal conditions (e.g., a low stress scenario, as indicated by the biometric readings).

The media content upload management module 510-a may be used to filter the media content streamed to another wireless device based on one or more sensor readings of the wireless device 115-g. In some examples, the media content upload management module 510-a may adapt the streaming of media content for the purpose of increasing the likelihood that the streaming continues without interruption or degradation, or for the purpose of ensuring that the streaming is of a desired minimum quality, or to ease the processing burden on the wireless device 115-g.

In some examples, the wireless network over which media content is streamed may be a WWAN, and the media content may be streamed over an IMS of the WWAN. In some examples, the wireless network over which media content is streamed may be a WLAN.

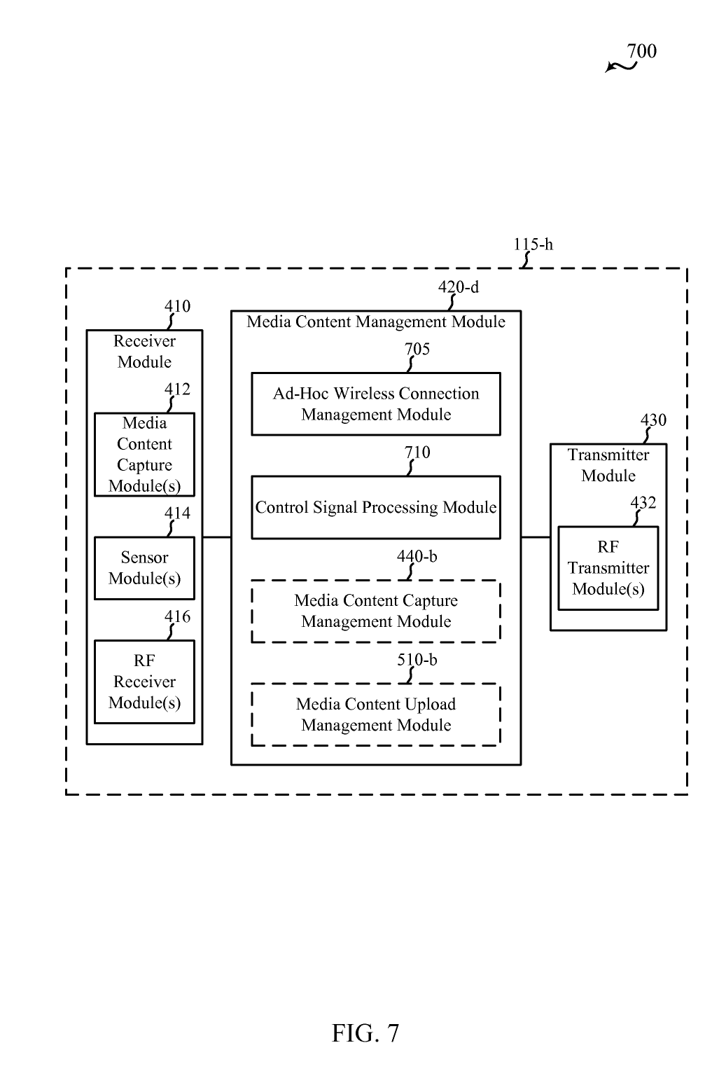

FIG. 7 shows a block diagram 700 of a wireless device 115-h for use in wireless communication, in accordance with various embodiments. In some examples, the wireless device 115-h may be an example of aspects of one of the wireless devices 115 described with reference to FIGS. 1, 2, 3, 4, 5, and/or 6. The wireless device 115-h may also be a processor. The wireless device 115-h may include a receiver module 410, a media content management module 420-d, and a transmitter module 430. Each of these components may be in communication with each other.

The components of the wireless device 115-h may, individually or collectively, be implemented using one or more ASICs adapted to perform some or all of the applicable functions in hardware. Alternatively, the functions may be performed by one or more other processing units (or cores), on one or more integrated circuits. In other examples, other types of integrated circuits may be used (e.g., Structured/Platform ASICs, FPGAs, and other Semi-Custom ICs), which may be programmed in any manner known in the art. The functions of each unit may also be implemented, in whole or in part, with instructions embodied in a memory, formatted to be executed by one or more general or application-specific processors.

In some examples, the receiver module 410 and transmitter module 430 may be configured as described with reference to FIG. 4. The receiver module 410 may include, for example, one or more media content capture module(s) 412, one or more sensor module(s) 414, and/or one or more RF receiver module(s) 416. The transmitter module 430 may include, for example, one or more RF transmitter module(s) 432.

The media content management module 420-d may be used to manage various functions related to media content capture and/or media content upload. In some examples, the media content management module 420-d may be an example of the media content management module 420 described with reference to FIG. 4, 5, or 6. In some examples, the media content management module 420-d may include an ad-hoc wireless connection management module 705, a control signal processing module 710, a media content capture management module 440-b, and a media content upload management module 510-b.

The ad-hoc wireless connection management module 705 may be used to establish an ad-hoc wireless connection with another wireless device. Establishment of the ad-hoc connection may be initiated by a user of the wireless device 115-h and/or a user of the other wireless device (or a user of a device connected to the other wireless device). The ad-hoc wireless connection may be established, for example, to enable a user of the other wireless device to control the capture and streaming of media content at the wireless device 115-h. This may be especially useful when the user of the wireless device 115-h is unable to dynamically control the capture and streaming of media content at the wireless device 115-h (e.g., because the user of the wireless device 115-h is engaged in a workout, participating in a supporting event, or otherwise unable to control the wireless device 115-h).

In some examples, a technology such as AllJoyn™ may be used to advertise that the wireless device 115-h is capable of being controlled and/or monitored by other wireless devices in its vicinity.

The control signal processing module 710 may be used to process control signals received via the ad-hoc wireless connection. In some examples, the control signal processing module 710 may be used to determine whether a received control signal relates to media content capture and/or media upload/streaming. When the control signal relates to media content capture, the control signal processing module 710 may pass or apply the control signal to the media content capture management module 440-b. When the control signal relates to media content upload/streaming, the control signal processing module 710 may pass or apply the control signal to the media content upload management module 510-b.

The media content capture management module 440-b may be configured as described with reference to the media content capture management module 440 described with reference to FIG. 4 or 6, with the capture of media content being adjusted based on one or more control signals received via an ad-hoc wireless connection. In some examples, a control signal may specify: when the media content capture management module 440-b is to commence or end media content capture; the format in which media content is to be capture and/or stored; the panning or zoom of a camera; the volume of an audio feed capture; and/or one or more triggers for commencing or ending media content capture. The media content capture management module 440-b may be an example of the media content capture management module 440 described with reference to FIGS. 4 and/or 6.

The media content upload management module 510-b may be configured as described with reference to the media content upload management module 510 described with reference to FIG. 5 or 6, with the upload/streaming of media content being adjusted based on one or more control signals received via an ad-hoc wireless connection. In some examples, a control signal may specify how, when, under what conditions (e.g., sensor readings), and/or to what devices media content should be streamed. A control signal may also specify, for example, whether sensor readings should be streamed with the media content. The media content upload management module 510-b may be an example of the media content upload management module 510 described with reference to FIGS. 5 and/or 6.

In some examples, at least a portion of media content captured and/or stored at the wireless device 115-h may be streamed to a wireless device that is connected to the wireless device 115-h over an ad-hoc connection. The media content streamed to a wireless device that is connected to the wireless device 115-h may be further uploaded/streamed to one or more other devices, over one or more wireless and/or wired networks. This may allow for power saving at the wireless device 115-h or alleviate constraints between real-time capture and upload at the wireless device 115-h. In some examples, at least a portion of media content captured and/or stored at the wireless device 115-h may be streamed to a wireless device other than a wireless device that is connected to the wireless device 115-h over an ad-hoc connection.

In some examples, a wireless network over which media content is streamed may be a WWAN, and the media content may be streamed over an IMS of the WWAN. In some examples, the wireless network over which media content is streamed may be a WLAN.

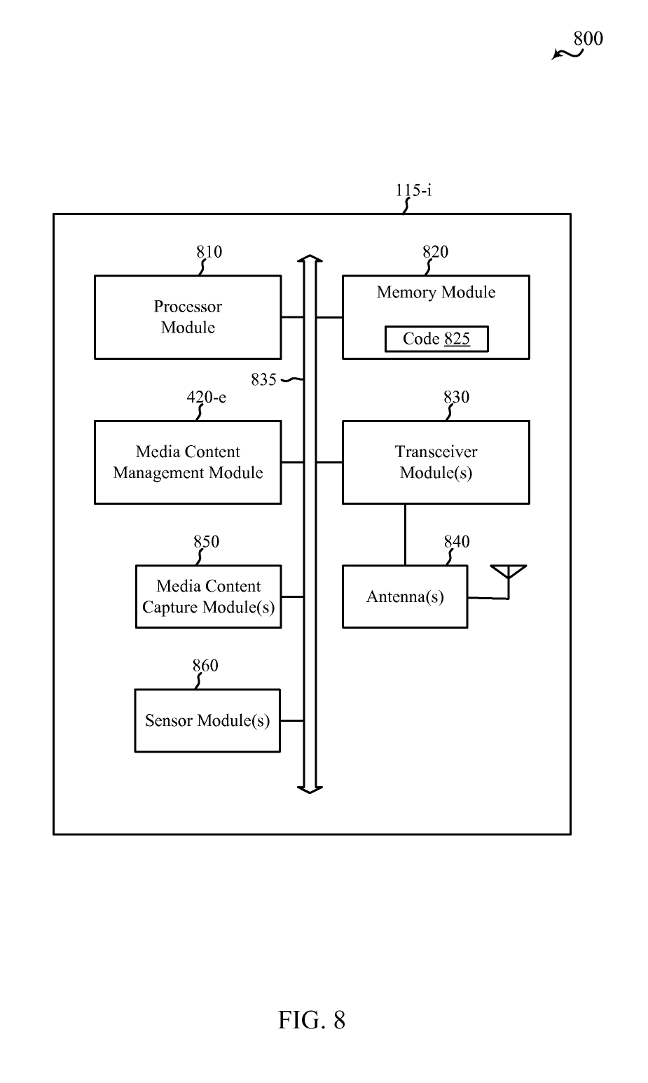

FIG. 8 shows a block diagram 800 of a wireless device 115-i for use in wireless communication, in accordance with various embodiments. The wireless device 115-i may have various configurations and may be included or be part of a camera (e.g., a video camera and/or a still camera), a personal computer (e.g., a laptop computer, a netbook computer, a tablet computer, etc.), a cellular telephone, a PDA, a digital video recorder (DVR), an internet appliance, a gaming console, an e-reader, etc. The wireless device 115-i may, in some examples, have an internal power supply (not shown), such as a small battery, to facilitate mobile operation. In some examples, the wireless device 115-i may be an example of aspects of one or more of the wireless devices 115 described with reference to FIGS. 1, 2, 3, 4, 5, 6, and/or 7 described with reference to FIGS. 1, 2, 3, 4, 5, 6, and/or 7, and/or the wireless device 115-i may be configured to implement one or more of the features and/or functions of the wireless device 115 described with reference to FIGS. 1, 2, 3, 4, 5, 6, and/or 7.

The wireless device 115-i may include a processor module 810, a memory module 820, at least one transceiver module (represented by transceiver module(s) 830), at least one antenna (represented by antenna(s) 840), a media content capture module (represented by media content capture module(s) 850), a sensor module (represented by sensor module(s) 860), and/or a media content management module 420-e. Each of these components may be in communication with each other, directly or indirectly, over one or more buses 835.

The memory module 820 may include random access memory (RAM) and/or read-only memory (ROM). The memory module 820 may store computer-readable, computer-executable code 825 containing instructions that are configured to, when executed, cause the processor module 810 to perform various functions described herein related to media content capture and/or wireless communication. Alternatively, the code 825 may not be directly executable by the processor module 810 but be configured to cause the wireless device 115-i (e.g., when compiled and executed) to perform various of the functions described herein.

The processor module 810 may include an intelligent hardware device, e.g., a central processing unit (CPU), a microcontroller, an ASIC, etc. The processor module 810 may process information received through the transceiver module(s) 830 and/or information to be sent to the transceiver module(s) 830 for transmission through the antenna(s) 840. The processor module 810 may also process information received via the media content capture module(s) 850 and/or one or more of the sensor module(s) 860. The processor module 810 may manage, alone or in connection with the media content management module 420-e, various aspects of media content capture and/or media content streaming.

The transceiver module(s) 830 may include a modem configured to modulate packets and provide the modulated packets to the antenna(s) 840 for transmission, and to demodulate packets received from the antenna(s) 840. The transceiver module(s) 830 may, in some examples, be implemented as one or more transmitter modules and one or more separate receiver modules. The transceiver module(s) 830 may support communications in one or more radio frequency spectrum bands using one or more RATs. The transceiver module(s) 830 may be configured to communicate bi-directionally, via the antenna(s) 840, with one or more of the base stations 105 described with reference to FIGS. 1 and/or 2, and/or one or more of the wireless devices 115 described with reference to FIGS. 1, 2, 3, 4, 5, 6, and/or 7. While the wireless device 115-i may include a single antenna, there may be examples in which the wireless device 115-i may include multiple antennas 840.

The media content capture module(s) 850 may include, for example, a camera (e.g., a video camera and/or still camera including an image sensor, such as a CMOS image sensor) and/or a microphone.

The sensor module(s) 860 may include one or more of a geographic location sensor (e.g., a GPS), a motion sensor, an accelerometer, a barometer, an audio sensor, or a biometric sensor (e.g., a pulse sensor or bioelectric impedance sensor).

The media content management module 420-e may be configured to perform and/or manage some or all of the features and/or functions described with reference to FIGS. 1, 2, 3, 4, 5, 6, and/or 7 related to media content capture and/or media content streaming. The media content management module 420-e, or portions of it, may include a processor, and/or some or all of the functions of the media content management module 420-e may be performed by the processor module 810 and/or in connection with the processor module 810. In some examples, the media content management module 420-e may be an example of the media content management module 420-e described with reference to FIGS. 4, 5, 6, and/or 7.

In some examples, aspects of the wireless devices 115 described with reference to FIGS. 1, 2, 3, 4, 5, 6, 7, and/or 8 may be combined.

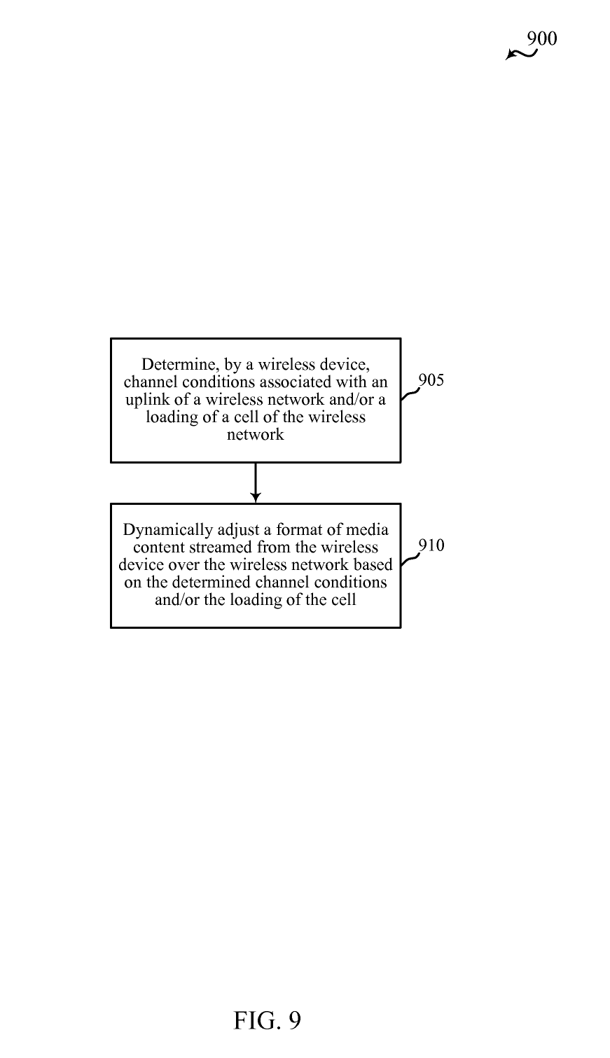

FIG. 9 is a flow chart illustrating an example of a method 900 for wireless communication, in accordance with various embodiments. For clarity, the method 900 is described below with reference to aspects of one or more of the wireless devices 115 described with reference to FIGS. 1, 2, 3, 4, 5, 6, 7, and/or 8. In some examples, a wireless device 115 may execute one or more sets of codes to control the functional elements of the wireless device 115 to perform the functions described below.

At block 905, a wireless device 115 may determine channel conditions associated with an uplink of a wireless network. Also or alternatively at block 905, the wireless device 115 may determine a loading of a cell of the wireless network. The loading of the cell of the wireless network may be determined based on a quality of service (QoS) grant received by a base station 105. The loading of the cell of the wireless network may also be determined based on monitoring a PDCCH and determining how many users are requesting uplink/downlink resources from the base station. The operation(s) at block 905 may be performed using the media content management module 420 described with reference to FIGS. 4, 5, 6, 7, and/or 8, the channel condition determination module 505 described with reference to FIGS. 5 and/or 6, and/or the network loading determination module 615 described with reference to FIG. 6.

At block 910, a format of media content streamed from the wireless device 115 over the wireless network may be dynamically adjusted based on the determined channel conditions and/or the loading of the cell of the wireless network. The operation(s) at block 910 may be performed using the media content management module 420 described with reference to FIGS. 4, 5, 6, 7, and/or 8, the media content upload management module 510 described with reference to FIGS. 5, 6, and/or 7, and/or the dynamic format adjustment module 620 described with reference to FIG. 6.

In some examples of the method 900, determining the channel conditions associated with the uplink of the wireless network may include receiving CSI for the uplink from the wireless network, and determining the channel conditions based on the CSI. The channel conditions may be determined based on the CSI using the media content management module 420 described with reference to FIGS. 4, 5, 6, 7, and/or 8, the channel condition determination module 505 described with reference to FIGS. 5 and/or 6, and/or the uplink channel quality determination module 605 described with reference to FIG. 6.

In some examples of the method 900, determining the channel conditions associated with the uplink of the wireless network may include estimating an uplink throughput of the wireless network. In some examples, the uplink throughput of the wireless network may be estimated based on a RAT (e.g., LTE, LTE-A, HSPA, HSPA+, EVDO, Wi-Fi, etc.) of the wireless network, an uplink channel quality of the wireless network, or a combination thereof. The uplink throughput may be estimated using the media content management module 420 described with reference to FIGS. 4, 5, 6, 7, and/or 8, the channel condition determination module 505 described with reference to FIGS. 5 and/or 6, and/or the uplink channel quality determination module 605 and/or uplink throughput estimation module 610 described with reference to FIG. 6.

In some examples of the method 900, determining the loading of the cell of the network may include determining a loading parameter based on a QoS grant or a monitored control channel broadcast by a base station of the cell, as described above.

In some examples of the method 900, dynamically adjusting the format of the media content may include dynamically adjusting a streaming bandwidth of the media content to match the estimated uplink throughput of the wireless network. In some examples of the method 900, dynamically adjusting the format of the media content may include dynamically adjusting an encoding of the media content. In a video streaming context, dynamically adjusting the format of a video stream may include, for example, adjusting the video stream to a 1080p, 720p, or 480 lines per inch video quality.

In some examples of the method 900, the wireless network over which media content is streamed may be a WWAN, and the media content may be streamed over an IMS of the WWAN. In some examples, the wireless network over which media content is streamed may be a WLAN.

Thus, the method 900 may provide for wireless communication. It should be noted that the method 900 is just one implementation and that the operations of the method 900 may be rearranged or otherwise modified such that other implementations are possible.

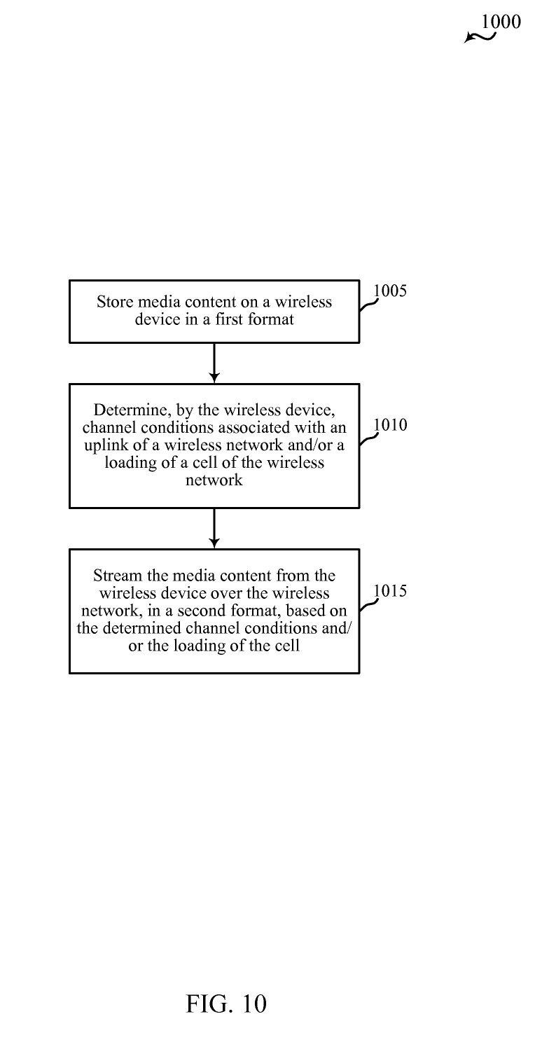

FIG. 10 is a flow chart illustrating an example of a method 1000 for wireless communication, in accordance with various embodiments. For clarity, the method 1000 is described below with reference to aspects of one or more of the wireless devices 115 described with reference to FIGS. 1, 2, 3, 4, 5, 6, 7, and/or 8. In some examples, a wireless device 115 may execute one or more sets of codes to control the functional elements of the wireless device 115 to perform the functions described below.

At block 1005, media content may be stored on a wireless device 115 in a first format. The operation(s) at block 1005 may be performed using the media content management module 420 described with reference to FIGS. 4, 5, 6, 7, and/or 8, and/or the media content capture management module 440 described with reference to FIGS. 4, 6, and/or 7.

At block 1010, the wireless device 115 may determine channel conditions associated with an uplink of a wireless network. Also or alternatively at block 1010, the wireless device 115 may determine a loading of a cell of the wireless network. The operation(s) at block 1010 may be performed using the media content management module 420 described with reference to FIGS. 4, 5, 6, 7, and/or 8, the channel condition determination module 505 described with reference to FIGS. 5 and/or 6, and/or the network loading determination module 615 described with reference to FIG. 6.

At block 1015, the media content may be streamed from the wireless device 115 over the wireless network in a second format, which second format differs from the first format. For example, the media content may be changed from a movie to a set of still images, or between formats with different amounts of lossiness or compression. The streaming of the media content in the second format may in some examples be based on the determined channel conditions and/or the loading of the cell of the wireless network. The operation(s) at block 1015 may be performed using the media content management module 420 described with reference to FIGS. 4, 5, 6, 7, and/or 8, the media content upload management module 510 described with reference to FIGS. 5, 6, and/or 7, and/or the format conversion module 625 described with reference to FIG. 6.

In some examples of the method 1000, the wireless network over which media content is streamed may be a WWAN, and the media content may be streamed over an IMS of the WWAN. In some examples, the wireless network over which media content is streamed may be a WLAN.

Thus, the method 1000 may provide for wireless communication. It should be noted that the method 1000 is just one implementation and that the operations of the method 1000 may be rearranged or otherwise modified such that other implementations are possible. In some examples, the method 1000 may be performed in conjunction with the method 900 described with reference to FIG. 9, and/or by the same wireless device 115 that performs the method 900.

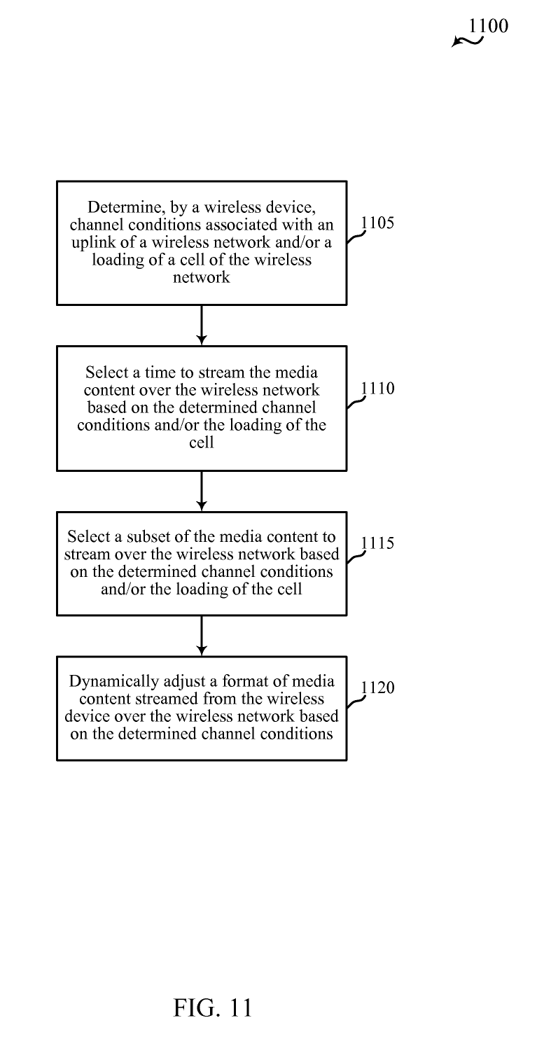

FIG. 11 is a flow chart illustrating an example of a method 1100 for wireless communication, in accordance with various embodiments. For clarity, the method 1100 is described below with reference to aspects of one or more of the wireless devices 115 described with reference to FIGS. 1, 2, 3, 4, 5, 6, 7, and/or 8. In some examples, a wireless device 115 may execute one or more sets of codes to control the functional elements of the wireless device 115 to perform the functions described below.

At block 1105, a wireless device 115 may determine channel conditions associated with an uplink of a wireless network. Also or alternatively at block 1105, the wireless device 115 may determine a loading of a cell of the wireless network. The operation(s) at block 1105 may be performed using the media content management module 420 described with reference to FIGS. 4, 5, 6, 7, and/or 8, the channel condition determination module 505 described with reference to FIGS. 5 and/or 6, and/or the network loading determination module 615 described with reference to FIG. 6.

At block 1110, a time to stream the media content over the wireless network may be selected based on the determined channel conditions and/or a loading parameter, based on the loading of the cell of the wireless network. In some examples, selecting a time to stream the media content may include delaying streaming the media content over the wireless network until channel conditions or the loading parameter improves. In some cases, streaming the media content may be delayed until a CSI parameter for the uplink improves. The operation(s) at block 1110 may be performed using the media content management module 420 described with reference to FIGS. 4, 5, 6, 7, and/or 8, the media content upload management module 510 described with reference to FIGS. 5, 6, and/or 7, and/or the upload timing selection module 630 described with reference to FIG. 6.

At block 1115, a subset of the media content to stream over the wireless network may be selected based on the determined channel conditions and/or the loading of the cell of the wireless network. The operation(s) at block 1115 may be performed using the media content management module 420 described with reference to FIGS. 4, 5, 6, 7, and/or 8, the media content upload management module 510 described with reference to FIGS. 5, 6, and/or 7, and/or the upload content selection module 635 described with reference to FIG. 6.

At block 1120, a format of media content streamed from the wireless device 115 over the wireless network may be dynamically adjusted based on the determined channel conditions and/or the loading of the cell of the wireless network. The operation(s) at block 1120 may be performed using the media content management module 420 described with reference to FIGS. 4, 5, 6, 7, and/or 8, the media content upload management module 510 described with reference to FIGS. 5, 6, and/or 7, and/or the dynamic format adjustment module 620 described with reference to FIG. 6.

In some examples of the method 1100, determining the channel conditions associated with the uplink of the wireless network may include receiving CSI for the uplink from the wireless network, and determining the channel conditions based on the CSI. The channel conditions may be determined based on the CSI using the media content management module 420 described with reference to FIGS. 4, 5, 6, 7, and/or 8, the channel condition determination module 505 described with reference to FIGS. 5 and/or 6, and/or the uplink channel quality determination module 605 described with reference to FIG. 6.

In some examples of the method 1100, determining the channel conditions associated with the uplink of the wireless network may include estimating an uplink throughput of the wireless network. In some examples, the uplink throughput of the wireless network may be estimated based on a RAT (e.g., LTE, LTE-A, HSPA, HSPA+, EVDO, Wi-Fi, etc.) of the wireless network, an uplink channel quality of the wireless network, or a combination thereof. The uplink throughput may be estimated using the media content management module 420 described with reference to FIGS. 4, 5, 6, 7, and/or 8, the channel condition determination module 505 described with reference to FIGS. 5 and/or 6, and/or the uplink channel quality determination module 605 and/or uplink throughput estimation module 610 described with reference to FIG. 6.

In some examples of the method 1100, dynamically adjusting the format of the media content may include dynamically adjusting a streaming bandwidth of the media content to match the estimated uplink throughput of the wireless network. In some examples of the method 1100, dynamically adjusting the format of the media content may include dynamically adjusting an encoding of the media content. In a video streaming context, dynamically adjusting the format of a video stream may include, for example, adjusting the video stream to a 1080p, 720p, or 480 lines per inch video quality.

In some examples of the method 1100, the wireless network over which media content is streamed may be a WWAN, and the media content may be streamed over an IMS of the WWAN. In some examples, the wireless network over which media content is streamed may be a WLAN.

In some examples, one or more of the operations at block 1110, 1115, and/or 1120 may not be performed.

Thus, the method 1100 may provide for wireless communication. It should be noted that the method 1100 is just one implementation and that the operations of the method 1100 may be rearranged or otherwise modified such that other implementations are possible. In some examples, the method 1100 may be performed in conjunction with the method 900 and/or 1000 described with reference to FIGS. 9 and/or 10, and/or by the same wireless device 115 that performs the method 900 and/or 1000.

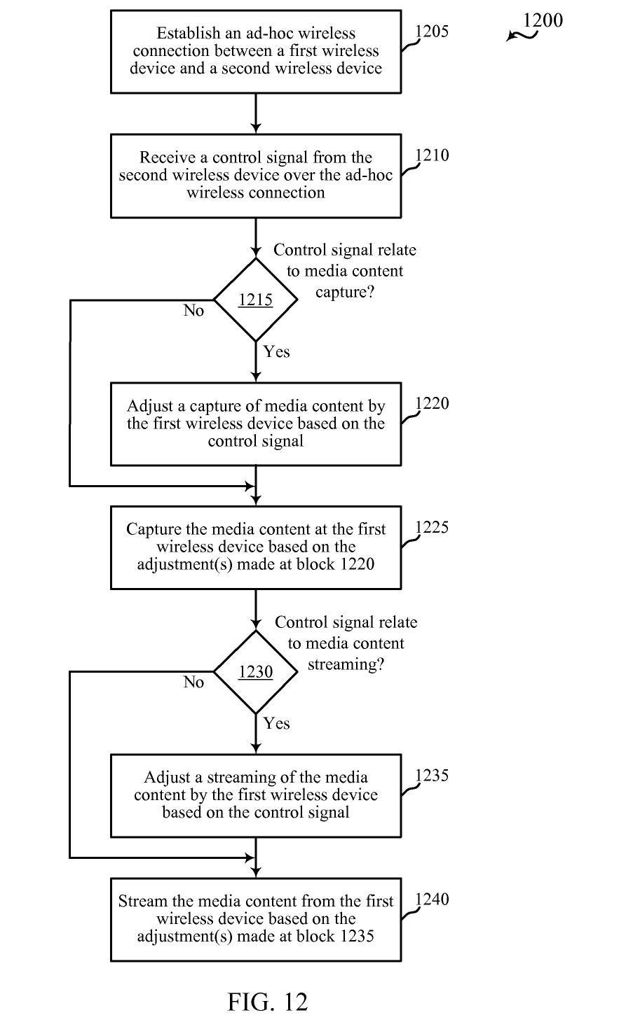

FIG. 12 is a flow chart illustrating an example of a method 1200 for wireless communication, in accordance with various embodiments. For clarity, the method 1200 is described below with reference to aspects of two or more of the wireless devices 115 described with reference to FIGS. 1, 2, 3, 4, 5, 6, 7, and/or 8. In some examples, a wireless device 115 may execute one or more sets of codes to control the functional elements of the wireless device 115 to perform the functions described below.

At block 1205, an ad-hoc wireless connection may be established between a first wireless device 115 and a second wireless device 115. At block 1210, a control signal may be received (e.g., at the first wireless device 115) from the second wireless device 115 over the ad-hoc wireless connection. The operations at blocks 1205 and/or 1210 may be performed using the media content management module 420 described with reference to FIGS. 4, 5, 6, 7, and/or 8, and/or the ad-hoc wireless connection management module 705 and/or control signal processing module 710 described with reference to FIG. 7.

At block 1215, it may be determined whether the received control signal relates to media content capture. When the control signal relates to media content capture, the method 1200 may continue at block 1220. When the control signal does not relate to media content capture, the method 1200 may continue at block 1225.

At block 1220, a capture of media content by the first wireless device 115 may be adjusted based on the control signal. At block 1225, the media content may be captured at the first wireless device 115 based on the adjustment(s) made at block 1220.

The operation(s) at block 1215, 1220, and/or 1225 may be performed using the media content management module 420 described with reference to FIGS. 4, 5, 6, 7, and/or 8, and/or the media content capture management module 440 described with reference to FIGS. 4 and/or 7.

At block 1230, it may be determined whether the received control signal relates to media content streaming. When the control signal relates to media content streaming, the method 1200 may continue at block 1235. When the control signal does not relate to media content streaming, the method 1200 may continue at block 1240.

At block 1235, a streaming of media content by the first wireless device 115 may be adjusted based on the control signal. At block 1240, the media content may be streamed from the first wireless device 115 based on the adjustment(s) made at block 1235. In some examples, at least a portion of the media content may be streamed to the second wireless device 115 over the ad-hoc wireless connection. In some examples, at least a portion of the media content may be streamed over a wireless network. In some examples, the wireless network over which media content is streamed may be a WWAN, and the media content may be streamed over an IMS of the WWAN. In some examples, the wireless network over which media content is streamed may be a WLAN. In some examples, the at least portion of the media content may be streamed over the ad-hoc wireless connection and/or the wireless network using any one or more of the methods 900, 1000, and/or 1100 described with reference to FIGS. 9, 10, and/or 11.

The operation(s) at blocks 1230, 1235, and/or 1240 may be performed using the media content management module 420 described with reference to FIGS. 4, 5, 6, 7, and/or 8, and/or the media content upload management module 510 described with reference to FIGS. 5, 6, and/or 7.

Thus, the method 1200 may provide for wireless communication. It should be noted that the method 1200 is just one implementation and that the operations of the method 1200 may be rearranged or otherwise modified such that other implementations are possible. In some examples, the method 1200 may be performed in conjunction with the method 900, 1000, and/or 1100 described with reference to FIGS. 9, 10, and/or 11, and/or by the same wireless device 115 that performs the method 900, 1000, and/or 1100.

The detailed description set forth above in connection with the appended drawings describes examples and does not represent the only examples that may be implemented or that are within the scope of the claims. The terms “example” and “exemplary,” when used in this description, mean “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the spirit or scope of the disclosure. Throughout this disclosure the term “example” or “exemplary” indicates an example or instance and does not imply or require any preference for the noted example. Thus, the disclosure is not to be limited to the examples and designs described herein but is to be accorded the widest scope consistent with the principles and novel features disclosed herein.

What is claimed is:

1. A method for wireless communication, comprising:
determining, by a wireless device, channel conditions associated with an uplink of a wireless network;
determining a loading parameter of a cell of the wireless network; and
dynamically adjusting a format of media content streamed from the wireless device over the wireless network based on the determined channel conditions and the determined loading parameter of the cell of the wireless network.

2. The method of claim 1, further comprising:
selecting a time to stream the media content over the wireless network based on at least one of: the determined channel conditions and the determined loading parameter of the cell of the wireless network.

3. The method of claim 2, wherein selecting the time to stream the media content comprises:
delaying streaming the media content over the wireless network until the channel conditions improve or until the loading of the cell of the wireless network improves.

4. The method of claim 1, further comprising:
determining a quality of service (QoS) provided by the cell of the wireless network;
wherein the loading parameter of the cell of the wireless network is determined based at least in part on the determined QoS.

5. The method of claim 1, further comprising:
monitoring resource grants on a physical downlink control channel received from the cell of the wireless network;
wherein the loading parameter of the cell of the wireless network is determined based at least in part on the monitored resource grants.

6. The method of claim 1, wherein determining the channel conditions associated with the uplink of the wireless network comprises:
estimating an uplink throughput of the wireless network;
wherein the format of the media content is dynamically adjusted to match a streaming bandwidth of the media content to the estimated uplink throughput of the wireless network.

7. The method of claim 1, wherein determining the channel conditions associated with the uplink of the wireless network comprises:
receiving channel state information (CSI) for the uplink from the wireless network;
wherein the determined channel conditions are based on the CSI.

8. The method of claim 1, further comprising:
storing the media content on the wireless device in a first format; and
streaming the media content from the wireless device over the wireless network in a second format based at least in part on the determined channel conditions or the determined loading parameter.

9. The method of claim 1, further comprising:
selecting a subset of the media content to stream over the wireless network based on the determined channel conditions or the determined loading parameter.

10. The method of claim 1, wherein dynamically adjusting the format of the media content comprises:
dynamically adjusting an encoding of the media content.

11. An apparatus for wireless communication, comprising:
means for determining channel conditions associated with an uplink of a wireless network;
means for determining a loading parameter of a cell of the wireless network; and
means for dynamically adjusting a format of media content streamed from a wireless device over the wireless network based on the determined channel conditions and the determined loading parameter of the cell of the wireless network.

12. The apparatus of claim 11, further comprising:
means for selecting a time to stream the media content over the wireless network based on at least one of: the determined channel conditions and the determined loading parameter of the cell of the wireless network.

13. The apparatus of claim 12, wherein the means for selecting the time to stream the media content comprises:
means for delaying streaming the media content over the wireless network until the channel conditions improve or until the loading of the cell of the wireless network improves.

14. The apparatus of claim 11, further comprising:
means for determining a quality of service (QoS) provided by the cell of the wireless network;
wherein the loading parameter of the cell of the wireless network is determined based at least in part on the determined QoS.

15. The apparatus of claim 11, further comprising:
means for monitoring resource grants on a physical downlink control channel received from the cell of the wireless network;
wherein the loading parameter of the cell of the wireless network is determined based at least in part on the monitored resource grants.

16. The apparatus of claim 11, wherein the means for determining the channel conditions associated with the uplink of the wireless network comprises:
means for estimating an uplink throughput of the wireless network;
wherein the format of the media content is dynamically adjusted to match a streaming bandwidth of the media content to the estimated uplink throughput of the wireless network.

17. The apparatus of claim 11, wherein the means for determining the channel conditions associated with the uplink of the wireless network comprises:
means for receiving channel state information (CSI) for the uplink from the wireless network;
wherein the determined channel conditions are based on the CSI.

18. The apparatus of claim 11, further comprising:
means for storing the media content on the wireless device in a first format; and
means for streaming the media content from the wireless device over the wireless network in a second format based at least in part on the determined channel conditions or the determined loading parameter.

19. The apparatus of claim 11, further comprising:
means for selecting a subset of the media content to stream over the wireless network based on the determined channel conditions or the determined loading parameter.

20. An apparatus for wireless communication, comprising:
a processor;
memory in electronic communication with the processor; and
instructions stored in the memory, the instructions being executable by the processor to:
determine, by a wireless device, channel conditions associated with an uplink of a wireless network;
determine a loading parameter of a cell of the wireless network; and
dynamically adjust a format of media content streamed from the wireless device over the wireless network based on the determined channel conditions and the determined loading parameter of the cell of the wireless network.

21. The apparatus of claim 20, wherein the instructions are executable by the processor to:
select a time to stream the media content over the wireless network based on at least one of: the determined channel conditions and the determined loading parameter of the cell of the wireless network.

22. The apparatus of claim 21, wherein the instructions are executable by the processor to select the time to stream the media content comprise instructions executable by the processor to:
delay streaming the media content over the wireless network until the channel conditions improve or until the loading of the cell of the wireless network improves.

23. The apparatus of claim 20, wherein the instructions are executable by the processor to:
determine a quality of service (QoS) provided by the cell of the wireless network;
wherein the loading parameter of the cell of the wireless network is determined based at least in part on the determined QoS.

24. The apparatus of claim 20, wherein the instructions are executable by the processor to:
monitor resource grants on a physical downlink control channel received from the cell of the wireless network;
wherein the loading parameter of the cell of the wireless network is determined based at least in part on the monitored resource grants.

25. The apparatus of claim 20, wherein the instructions executable by the processor to determine the channel conditions associated with the uplink of the wireless network comprise instructions executable by the processor to:
estimate an uplink throughput of the wireless network;
wherein the format of the media content is dynamically adjusted to match a streaming bandwidth of the media content to the estimated uplink throughput of the wireless network.

26. The apparatus of claim 20, wherein the instructions executable by the processor to determine the channel conditions associated with the uplink of the wireless network comprise instructions executable by the processor to:
receive channel state information (CSI) for the uplink from the wireless network;
wherein the determined channel conditions are based on the CSI.

27. The apparatus of claim 20, wherein the instructions are executable by the processor to:
store the media content on the wireless device in a first format; and
stream the media content from the wireless device over the wireless network in a second format based at least in part on the determined channel conditions or the determined loading parameter.

28. The apparatus of claim 20, wherein the instructions are executable by the processor to:
select a subset of the media content to stream over the wireless network based on the determined channel conditions or the determined loading parameter.

29. The apparatus of claim 20, wherein the instructions executable by the processor to dynamically adjust the format of the media content comprise instructions executable by the processor to:
dynamically adjust an encoding of the media content.

30. A non-transitory computer-readable medium storing computer-executable code for wireless communication, the code executable by a processor to:
determine, by a wireless device, channel conditions associated with an uplink of a wireless network;
determine a loading parameter of a cell of the wireless network; and
dynamically adjust a format of media content streamed from the wireless device over the wireless network based on the determined channel conditions and the determined loading parameter of the cell of the wireless network.
